(19) United States
(12) Patent Application Publication
(10) Pub. No.: US 2017/0369291 A1
(43) Pub. Date: Dec. 28, 2017

(54) A LIFTING APPARATUS AND SYSTEM FOR SHIPPING CONTAINERS

(71) Applicant: Hy-Dynamix Limited, Durham (GB)

(72) Inventors: Glen Quickfall, Durham (GB); Graeme Parkins, Durham (GB)

(21) Appl. No.: 15/545,059

(22) PCT Filed: Jan. 20, 2016
(86) PCT No.: PCT/GB2016/050117

§ 371 Date: Jul. 20, 2017

(30) Foreign Application Priority Data
Jan. 20, 2015 (GB) 1500959.0

(51) Int. Cl. B66F 3/46; B66F 17/00; B66F 3/36

(52) U.S. Cl. CPC B66F 3/46; B66F 3/36; B66F 17/00

(57) ABSTRACT

A lifting apparatus and lifting system for lifting a shipping container (14) are disclosed. The lifting system uses four lifting apparatus one in each corner of the container (14). Each apparatus has a hydraulic cylinder (16) which is attached to a frame (24). A locking member (40, 90) also attached to the frame (24) engages the base corner block (44) of the shipping container (14) and locks thereto. There is also a container frame engaging member (60) which presses into engagement with the frame of the container (14) above the base corner block (44) but below the upper corner block (44). When the hydraulic cylinder (16) extends the container (14) is lifted and the container frame engaging member (60) presses into engagement with the frame of the container (14) locking the lifting apparatus onto the container (14).

The present invention relates to a lifting apparatus and system for lifting intermodal or shipping containers and relates particularly, but not exclusively, to a system for lifting shipping containers a short distance above the ground so as to be able to connect wheels to the shipping container to allow it to be moved a short distance.

Shipping containers are used extensively around the world for shipping goods but also for storage on factory sites. An empty 20 ft shipping container (dimensions 6 m×2.4 m×2.6 m) typically weighs 2.2 tonnes and can be filled to a gross weight of just over 30 tonnes. As a result, specialist equipment is required to manoeuvre a shipping container even a short distance and this is typically in the form of a specialist crane or forklift like vehicle. Such cranes and vehicles are expensive to hire making the process of moving a shipping container a short distance expensive.

Systems have been developed to assist in the lifting of shipping containers which attach to the top and bottom cast corner blocks of the shipping container allowing the system to be fixed to the container so that it can then be lifted using a hydraulic ram. However, such systems are heavy to use and difficult to securely fix to the corner blocks, particularly those at the top of the container (at the height of 2.6 m) therefore requiring two or more people to attach the systems to the containers.

Preferred embodiments of the present invention seek to overcome the above described disadvantages of the prior art.

According to an aspect of the present invention there is provided a lifting apparatus for use in a lifting system for lifting a cuboid shipping container, the apparatus comprising:—

at least one lifting device having a first portion with a ground surface engaging member and a second portion movable relative to said first portion;
at least one container corner aperture engaging member for engaging an aperture in a base corner block of a cuboid shipping container, said aperture engaging member connected to said second portion and in use bearing the weight of the container; and
at least one container frame engaging member connected to said second portion for engaging a portion of a frame of the container above the container base corner block and below an upper corner block vertically opposed to the base corner block.

By providing an apparatus with a container corner aperture engaging member and a container frame engaging member the advantage is provided that the position of the lifting device relative to the weight bearing corner aperture engaging member causes the frame engaging member to be pressed into engagement with the frame of the container. This results in a very secure connection between the lifting apparatus and the container and as a result, a compact lifting apparatus can be provided which is able to stably lift a corner of a shipping container. Because the lifting device must be located a short distance away from the base corner block of the container, the lifting force is being applied a short distance away from the part of the apparatus that is carrying the weight (the aperture engaging member) causing a turning moment to be applied to the apparatus about the aperture engaging member which in turn causes the frame engaging member to be pressed into engagement with the frame of the container. The greater the weight that is being lifted the greater the force that is applied by the frame engaging member. As a result, the apparatus, when used in conjunction with three similar apparatus, can be easily and safely handled by one operator working on the ground and at the base of the container to lift the container so that wheels can be attached to or positioned under the container. The operator does not require the specialist training needed to safely operate the specialist cranes and forklift like vehicles currently used to move shipping containers.

The apparatus may further comprise at least one body connected to said second portion, said container corner aperture engaging and said member container frame engaging member.

By providing a body to which the lifting device, container corner aperture engaging member and frame engaging member are all attached provides the advantage that a standard hydraulic cylinder can be used as the lifting device which is fixed to the body and the corner aperture engaging member and frame engaging member can also be easily attached.

Furthermore, the fixing of the hydraulic cylinder can be such that standard fixings on the hydraulic cylinder (for example an external thread around the end of the cylinder barrel) can be easily used to secure the cylinder to the body.

In a preferred embodiment the lifting device comprises at least one hydraulic cylinder.

In another preferred embodiment the first portion comprises a piston of said hydraulic cylinder and said second portion comprises a cylinder barrel of said hydraulic cylinder.

The container corner aperture engaging member may comprise a rod portion connected to said second portion and a locking flange at a distal end of said rod portion, said container corner aperture engaging member being rotatable relative to said second portion between an unlocked condition in which said flange is able to move into and out of the container corner block aperture and a locked condition in which said flanged is unable to move into or out of the container corner block aperture.

This aperture engaging member utilises a standard form of attachment for securely locking onto a shipping container. Furthermore, once engaged with the corner block aperture and carrying the weight of the container, it is impossible to detach the aperture engaging member from the corner block.

The apparatus may further comprise at least one sliding handle having a lever connected thereto for causing the rotation of said container corner aperture engaging member between said locked and unlocked conditions.

The apparatus may also further comprise at least one locking member for preventing movement of said sliding handle when said container corner aperture engaging member is in said locked condition.

In a preferred embodiment the container frame engaging member comprises a frame contact member and a positioning member for moving the frame contact member relative to said second portion of said lifting device.

Having a movable frame engaging member has the advantage that the frame engaging member can always be moved into engagement with the frame of the container irrespective of slight variations in the formation of the container or in situations where slight damage has occurred to the container. In order to ensure that the stresses on the lifting apparatus, in particular around the junction between components such as the body and the hydraulic lifting cylinder, are minimised it is important that the cylinder is lifting vertically upwards. As a result, the frame engaging member can be moved into engagement with the frame so as to prevent the apparatus from leaning inwards towards the frame of the container. It applies pressure to the container frame via the frame engaging member but remains acting vertically.

In another preferred embodiment the positioning member comprises a threaded member engaged with a threaded aperture connected to said second portion.

In a further preferred embodiment the threaded aperture is connected to said body.

In a preferred embodiment the container frame engaging member is in use located less than 1 metre above said container corner aperture engaging member.

An apparatus having a height of less than 1 m is significantly smaller, and therefore easier to handle, than lifting devices of the prior art.

The apparatus may further comprise at least one lifting trolley engaging member.

By providing a lifting trolley engaging member the advantage is provided that a lifting trolley can be used to lift and maneuver the lifting apparatus.

According to another aspect of the present invention there is provided a lifting system for lifting a cuboid shipping container, the system comprising:—

four lifting apparatus as set out above;
power connection means for connecting said lifting apparatus to a power supply; and
at least one control device for supplying power to said apparatus so as to move said first and second portions of said lifting device.

In a preferred embodiment the control device comprises at least one hydraulic fluid distribution device and said power connection means comprise a plurality of hydraulic hoses for connecting said hydraulic fluid distribution device to said lifting apparatus.

The control device may further comprise at least one pressure measuring device and at least one display device for displaying a weight being lifted by said lifting apparatus calculated from said measured pressure.

By including a pressure measuring device and converting the output of the pressure measuring device into a displayed weight, the advantage is provided that the apparatus can be used to simply weigh a shipping container to determine its weight and whether it complies with the limitations on weight for that container.

The control device may also further comprise a plurality of pressure measuring devices associated with each lifting apparatus and at least one display device for displaying a weight being lifted by each said lifting apparatus calculated from each said measured pressure.

In preferred embodiment the control device further comprises processing means for calculating a weight distribution based on each said measured pressure.

Measuring the weight distribution of the container can be particularly advantageous where it is important that a container is loaded with an even weight distribution as the apparatus of the present invention can be quickly used to determine whether or not a correct weight distribution has been achieved.

The system may further comprise a wheeled trolley having a trolley body and a pivoted lifting member with an apparatus engaging portion for engaging said trolley engaging member and a handle for applying a lifting force to the pivoted lifting member thereby lifting the apparatus for transporting.

The system may also further comprise wheeled members for attached to the container.

By attaching wheeled members to the container once it is lifted, the lifting device can then be retracted so as to lower the container onto the wheels allowing it to be easily moved.

Preferred embodiments of the present invention will now be described, by way of example only, and not and in any limitative sense with reference to the accompanying drawings in which:—

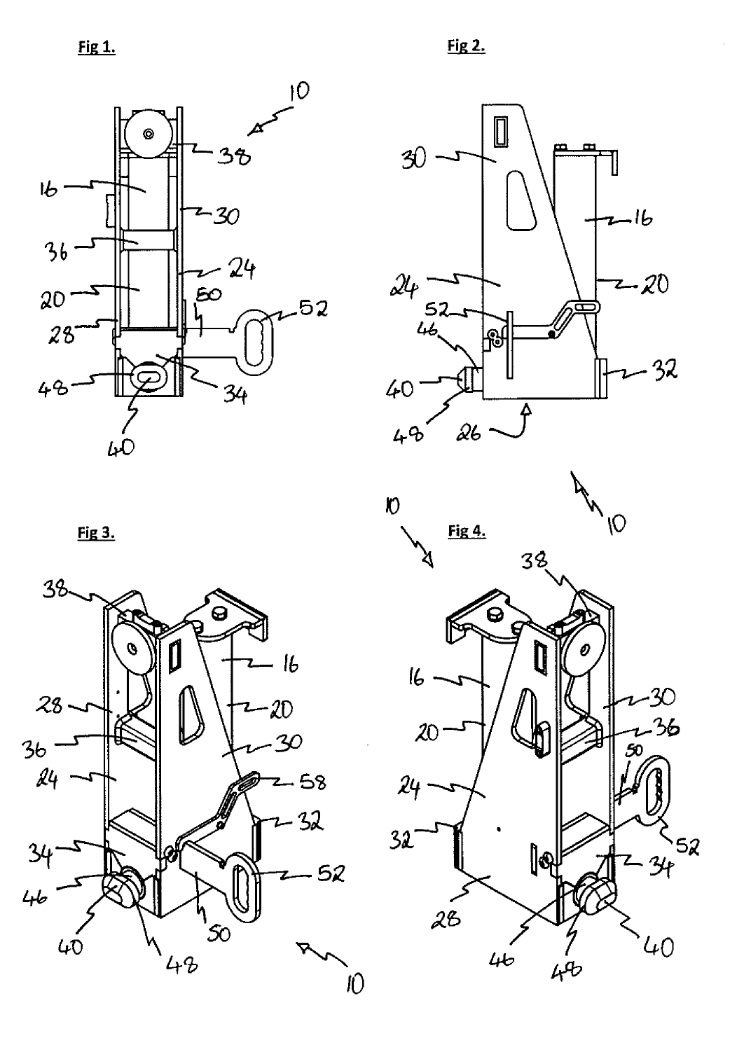

FIGS. 1 and 2 are front and side views of the lifting apparatus of the present invention;

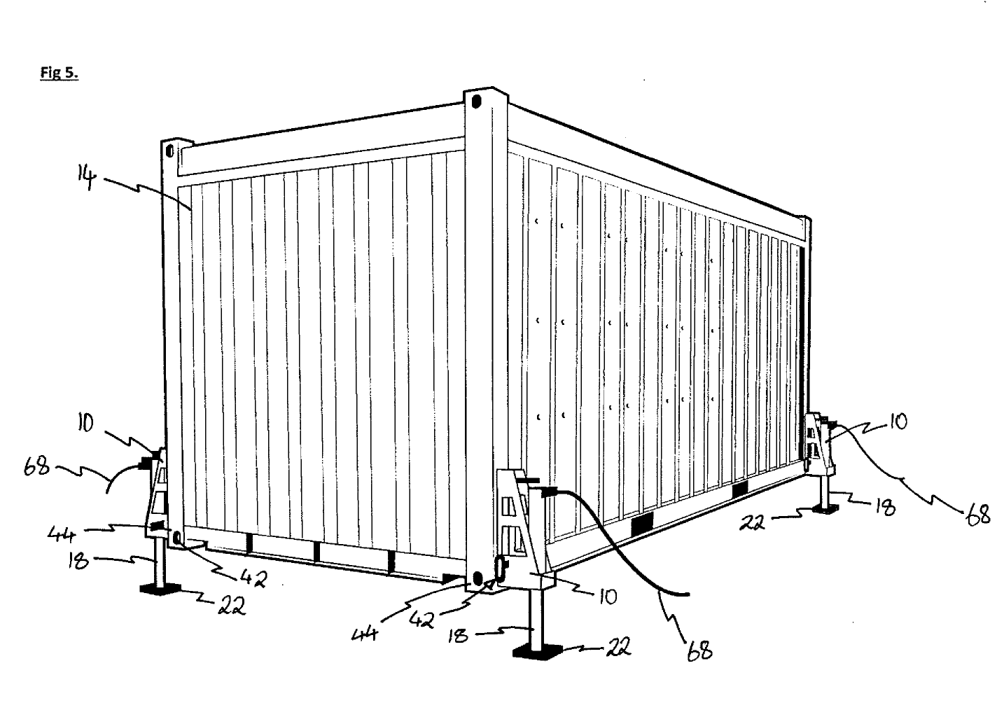

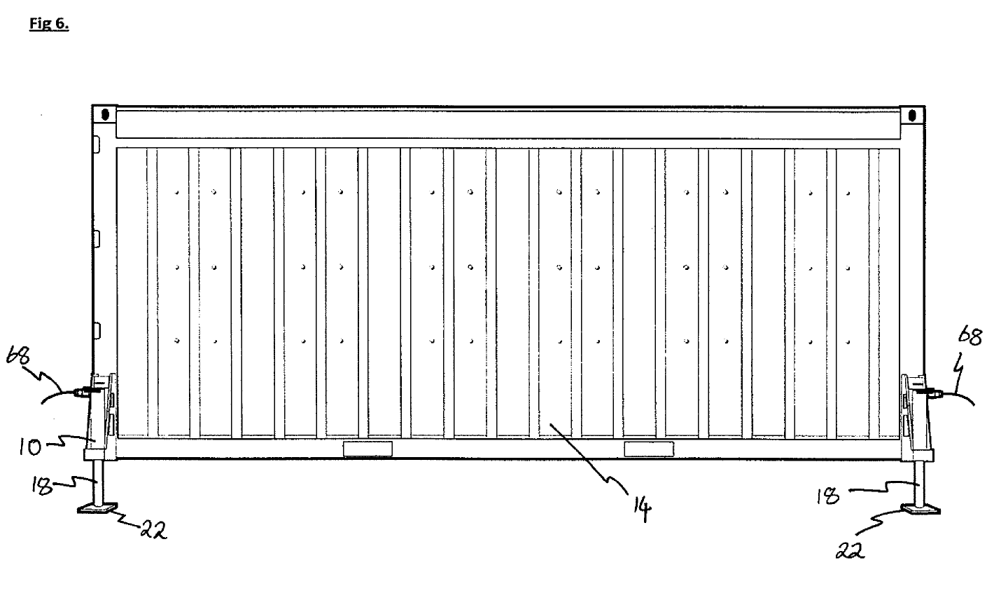

FIGS. 3 and 4 are perspective views of the lifting apparatus of FIGS. 1 and 2;

FIGS. 5 and 6 are perspective and front views of a shipping container being lifted by the apparatus of FIG. 1;

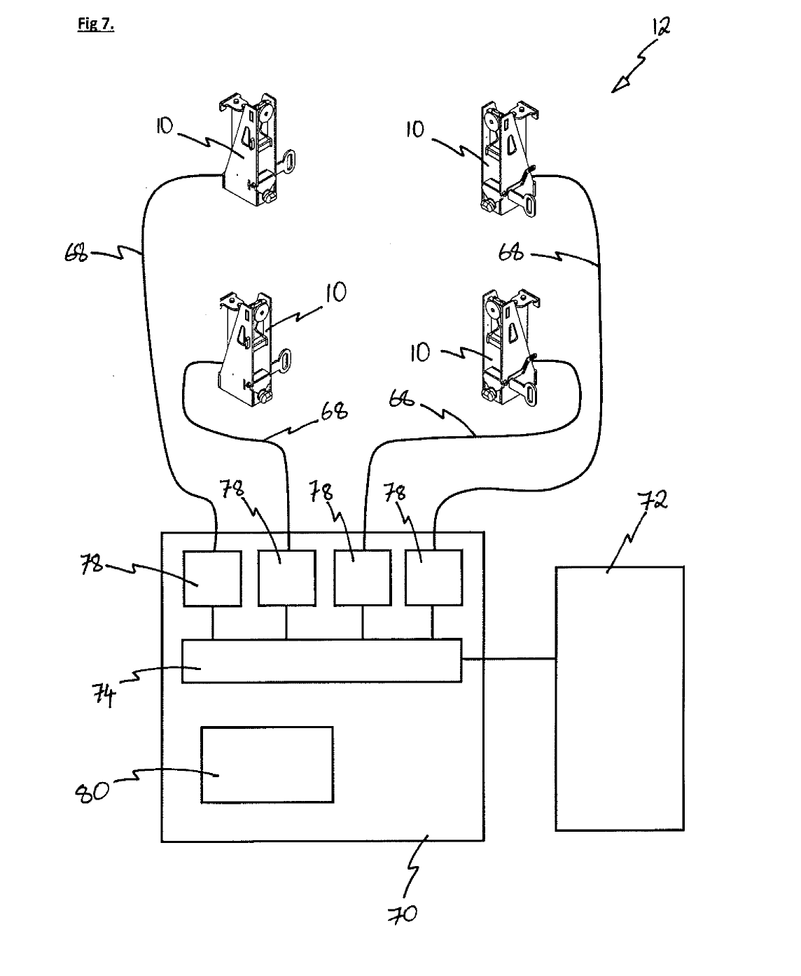

FIG. 7 is a schematic representation of a lifting system of the present invention incorporating the lifting apparatus of FIGS. 1 to 4;

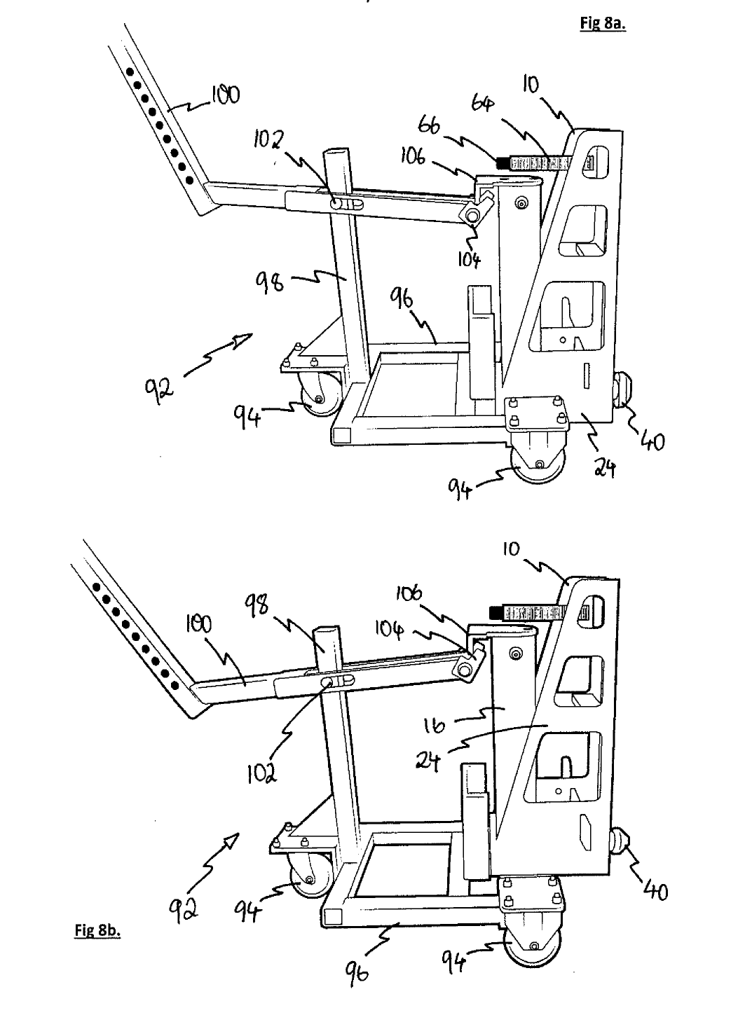

FIGS. 8a and 8b are perspective views of a trolley forming part of the system of the present invention respectively showing the apparatus of FIGS. 1 to 4 in lifted and lowered conditions;

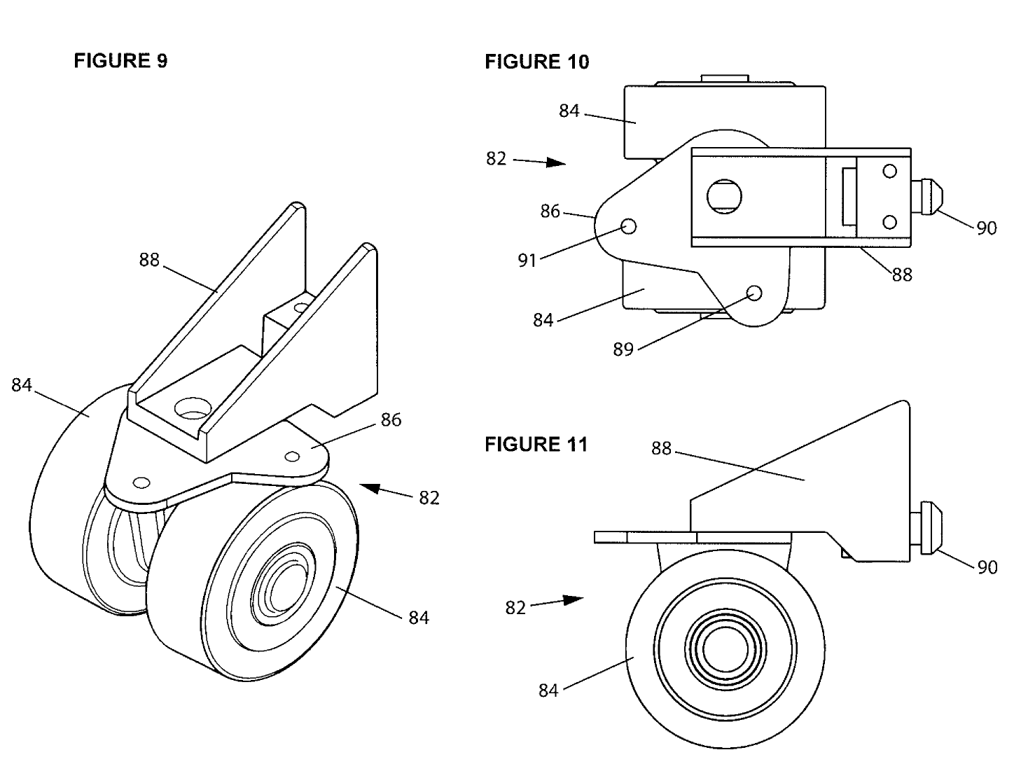

FIGS. 9, 10 and 11 are perspective, plan and front views of a wheel attachment for a container forming part of the system of the present invention;

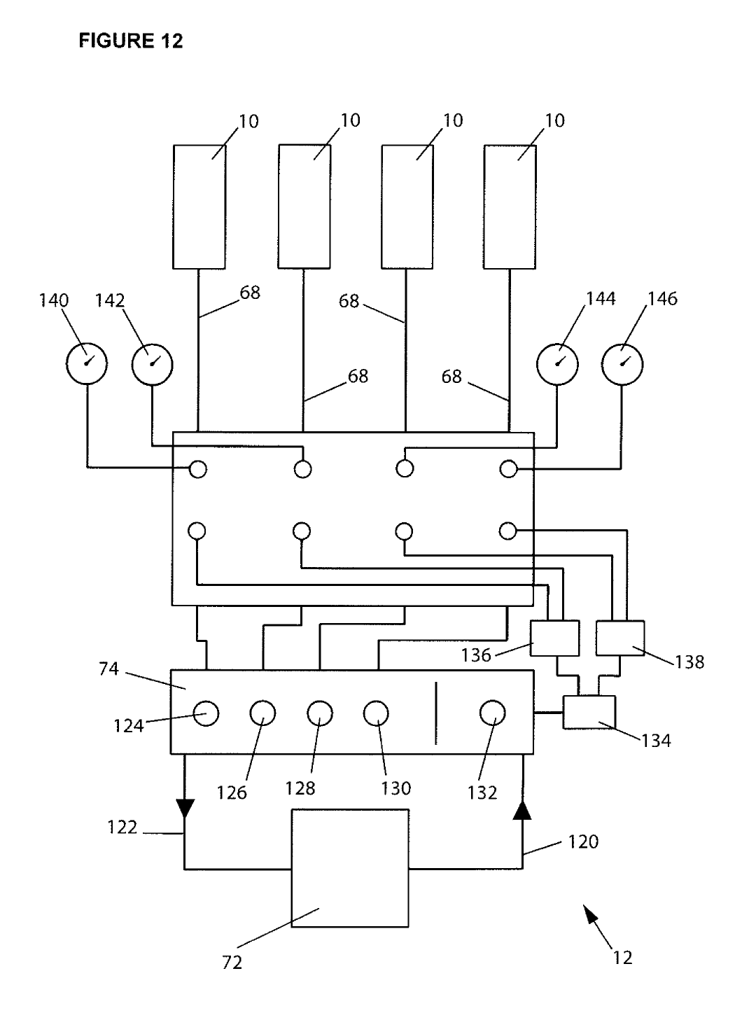

FIG. 12 is a further schematic representation of a lifting system of the present invention incorporating the lifting apparatus of FIGS. 1 to 4;

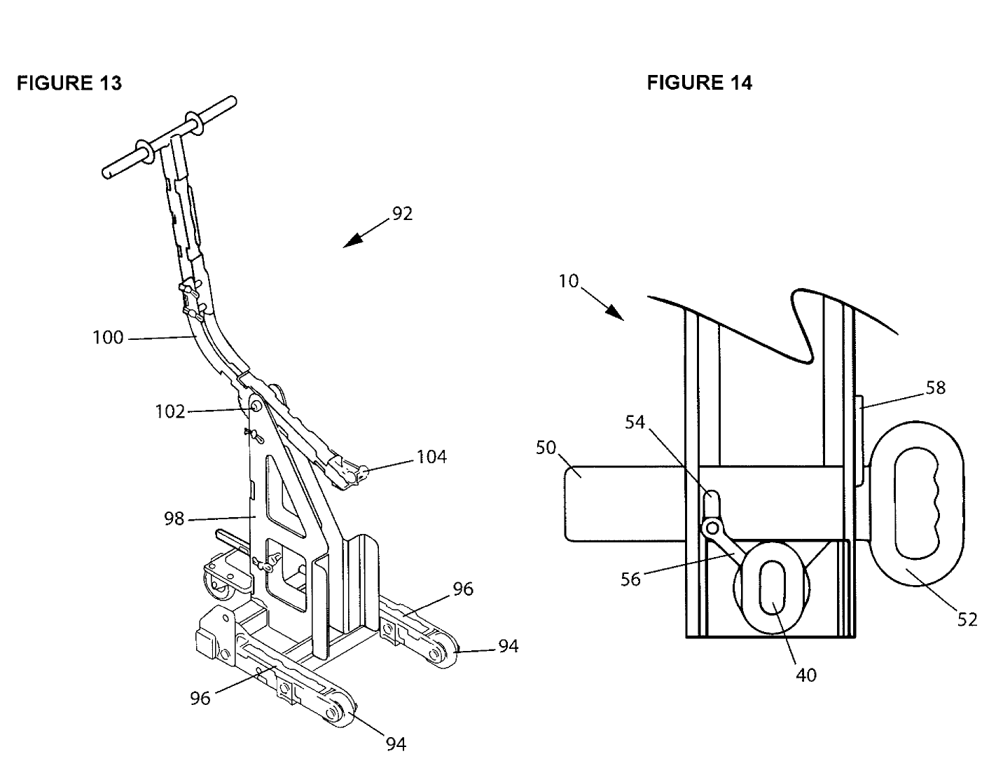

FIG. 13 is a perspective view of an alternative trolley to that shown in FIGS. 8a and 8b;

FIG. 14 is an end of a partial cutaway view of the apparatus as shown in FIG. 1;

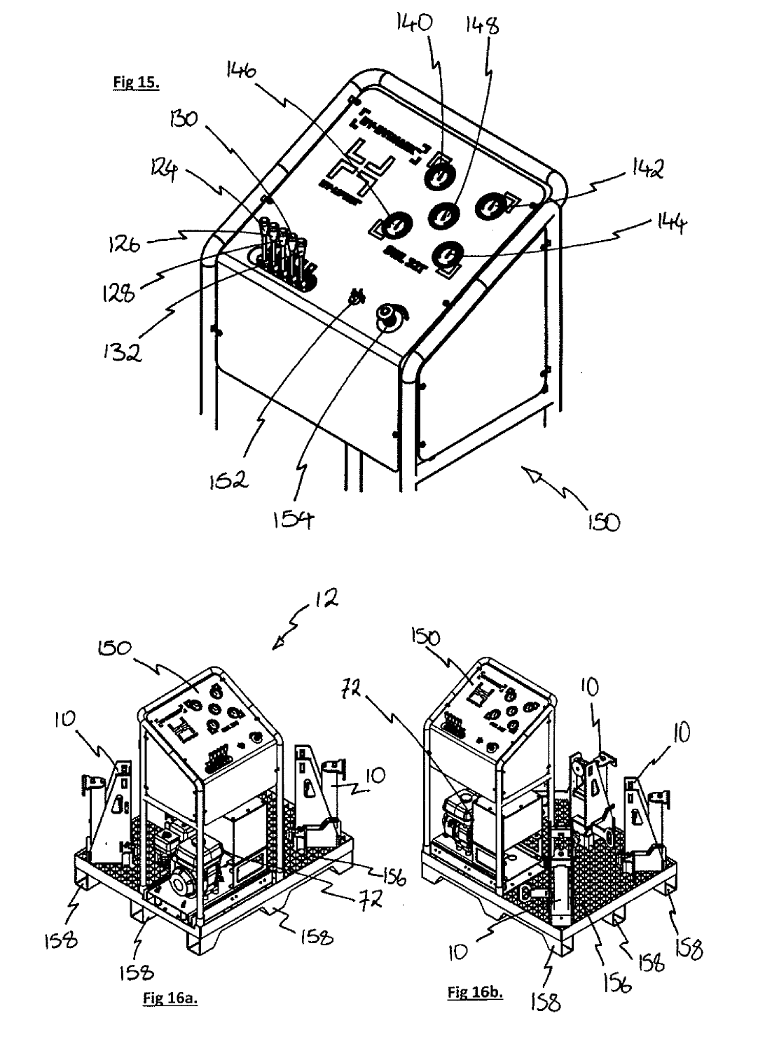

FIG. 15 is a perspective view of a control panel used in the system of FIG. 12; and

FIGS. 16a and 16b are perspective views of an embodiment of the system shown schematically in FIG. 12.

Referring to FIGS. 1 to 7, a lifting apparatus 10, for use in a lifting system 12 for lifting a cuboid intermodal or shipping container 14, is primarily shown in FIGS. 1 to 4. The apparatus 10 includes at least one lifting device, in the form of a hydraulic cylinder 16 which has a first portion, in the form of a piston 18 and a second portion in the form of cylinder barrel 20. By the introduction of hydraulic fluid under pressure, the piston 18 moves relative to the barrel 20. The piston 18 has, either formed as part of it or attached to it (fixedly or non-fixedly) a ground surface engaging member in the form of foot plate 22. An example of a hydraulic cylinder 16 which is used in the lifting apparatus 10 is a single acting cylinder with a maximum lift capacity of 25 tonnes and a stroke length of around 360 mm.

The cylinder 16 is attached to a body 24 of apparatus 10, which provides a frame to which other components of the apparatus are attached. The cylinder 16 is attached to the body 24 by engaging an external thread on cylinder barrel 20 with a matching internal thread in a base plate 26 of body 24. As well as the base plate 26, the body 24 has side walls 28 and 30, which are connected to either side of the base plate, and connecting members 32, 34, 36 and 38 which also connect the two side walls, with the connecting members 32 and 34 also attached to the base plate 26. This arrangement of the components of body 24 forms a frame to which the other components of the apparatus 10 are attached.

One of these attached components is a container corner aperture engaging member or locking member 40. This component engages with an aperture 42 in the corner block 44 of the shipping container 14 by extending into the aperture 42. The locking member 40 extends through connecting member 34 of body 24 and bears the weight of the container 14 when it is lifted. As a result the weight is transferred through the body 24 and into the hydraulic cylinder 16 by virtue of the body 24 and the cylinder barrel 20 being fixed to each other. The locking member 40 has a rod portion 46 and a flange 48. The rod portion 46 has a circular cross section, is closest to the body 24 and, when the apparatus is in use, acts to carry the weight of the container 14. The flange 48 is oval and is shaped to match the aperture 42 in corner block 44 of container 14. The locking member 40 is rotatable about the axis of rod portion 46. This rotation is achieved by the movement of a sliding bar 50 which has a handle 52 and which extends through a pair of apertures in the sidewalls 28 and 30 of the body 24. A slotted aperture 54 is provided in slide bar 50 and a lever 56, which is connected to locking member 40, extends into the slotted aperture (see FIG. 14). As a result, the sliding movement of sliding bar 50 pulls lever 56 causing the rotation of the locking member 40. The locking member 40 rotates between a first condition, in which the oval flange 48 is aligned vertically and therefore can freely move into and out of the similarly aligned aperture 42 in corner block 44, and a second condition, in which the oval flange is aligned horizontally and therefore cannot move into or out of the aperture in the corner block. Therefore in use the locking member 40 is initially rotated into the first condition so that the flange 48 can pass into the corner block 44, the locking member is then rotated and the flange 48 prevents the locking member 40 from being removed from the corner block 44 thereby maintaining the apparatus 10 in engagement with the shipping container 14. Once in the locked condition a sliding lock 58 slides into a slot in sliding bar 50 adjacent the handle 52 which prevents the handle being moved. The sliding lock 58 is sprung loaded so that it must be lifted out of the slot in sliding bar 50 before the bar can be moved.

A further component of the apparatus 10 is a container frame engaging member 60 which is connected to the body 24 via connecting member 38. The frame engaging member 60 has a frame contact member in the form of disc 62 and a positioning member 64 which is an externally threaded member attached to disc 62 and extending through a mutual internal thread formed in connecting member 38. This thread extends horizontally through the connecting member 38 and allows, by rotation of a hexagonal head 66 formed in the end of the positioning member 64, the frame engaging member 60 to be moved towards and away from the frame of the container. The frame engaging member 60 is located above the locking member 40 and these two components are separated by distance of less than 1 m and this distance is more preferably less than 500 mm making the total height of the apparatus 480 mm.

The lifting apparatus 10 forms part of the lifting system 12 which includes three other apparatus 10 with one for location in each corner of a shipping container 14. With each cylinder being able to lift 25 tonnes, the system with a device attached to each corner of a container can lift 100 tonnes (which is more than three times the capacity of a 20 ft container) to a height of around 360 mm. Each apparatus 10 is connected via a hydraulic hose 68 to a control panel 70 which controls the flow of hydraulic fluid from a pump 72. Within the control panel is a manifold 74 which splits the single flow from pump 72 into four separate flows for each hose 68. In the simplest arrangement the flow of hydraulic fluid and pressure to each of the lifting apparatus 10 is equal causing a uniform lift of the shipping container 14. However, each outlet from the manifold 74 has a flow controller allowing the pressure and flow rate to each lifting apparatus to be varied which can be used to accommodate lifting a shipping container on uneven ground. Downstream of the manifold 74 are four pressure sensors 78 one connected to each of the lifting apparatus 10. These pressure sensors 78 are used to determine the pressure of the hydraulic fluid within each cylinder and this pressure can be used to determine the weight being carried by each of the lifting apparatus 10 using the following formula:

W=Pₘ×W_{Max}/P_{O}

where: W is the weight being lifted by the cylinder (or system);
Pₘ is the measured pressure of the cylinder (or system);
W_{Max} is the maximum lift of the cylinder or system (which is four times the maximum lift of the cylinders);
P_{O} is the operating pressure of cylinders.

For example, for the system 12 described above with four apparatus 10 each having a cylinder 16 with a maximum lift capacity of 25 tonnes and the operating pressure of the system and each cylinder is 700 bar (70 MPa). Therefore, if each gauge is reading 175 bar (17.5 MPa) then the weight being lifted by each cylinder is (175×25)/700=6.25 tonnes. The total weight being lifted by the system (that is the weight of the container) is measured by adding each of the weights lifted by each apparatus (that is, 4×6.25=25 tonnes). In this example because each gauge is showing the same reading the distribution of weight within the container must be even. However, if the weight within the container is not evenly distributed the four gauges will give different readings resulting in different weights being calculated for each cylinder. These weights can be used to calculate the centre of gravity of the container which is particularly useful where a container is being lifted by suspension for example by a crane or helicopter.

In addition or as an alternative, a single gauge can measure the hydraulic fluid pressure before it is split by the manifold and by applying the same formula the weight of the container can be determined in a single calculation (although the centre of gravity of the container cannot be determined). In the above example the total maximum lift capacity of the system is 4×25=100 tonnes, the operating pressure of the system is the same (700 bar, 70 MPa) and the measured pressure of the system again 175 bar (17.5 MPa). Thus applying the above formula the total weight being lifted would be (175×100)/700=25 tonnes. Each of the sensors 76 may have its own display for the individual weights and total weight can be displayed on a display device 80 which can also be used to display the centre of gravity if calculated.

One of the main purposes for using the lifting system 12 is to lift the shipping container 14 to a sufficient height so that some form of wheels can be attached. This could be by the placing of one or more wheeled trolleys under the shipping container. Alternatively, the wheeled attachment devices 82 shown in FIGS. 9 to 11 are also suitable for attachment to the container 14. These attachment devices 82 have pairs of wheels 84 which are attached to a first body portion 86 which is itself rotatably mounted to a second body portion 88. A locking member 90, which is very similar in construction to locking member 40, is provided on the second body portion 88 and is used to mount and fix the attachment devices 82 to the base corner blocks 44 of shipping container 14. The attachment device 82 shown in FIGS. 9 to 11 is for the front left hand corner block of the container 14 (as you face the container). A similar attachment device is provided for the right-hand front corner block but this attachment devices are mirror-image of the one shown in FIGS. 9 to 11. Once both in position a tying rod is used to connect the apertures 89 and a V-shaped arrangement of rods connects the two front apertures 91 allowing the container to be towed via the apex of the V. Similar attachment devices are provided for the rear corner blocks. However, these do not require the apertures 89 and 91 and the first and second body portions 86 and 88 need not be rotatable and can be fixed.

The total weight of the lifting apparatus 10 is around 50 kg and therefore for ease of maneuvering a wheeled trolley 92 is provided. Referring to FIGS. 8a and 8b, the trolley 92 has wheels 94 and a frame 96 with an upstanding portion 98. Attached to the frame 96 is a pivoting lifting member 100 which pivots about a point 102 on upstanding portion 98. An apparatus engaging member 104 that is attached to lifting member 100 engages a trolley engaging member 106 on the barrel of the cylinder of the apparatus 10. An alternative embodiment of the trolley 92 is shown in FIG. 13 with components that are functionally equivalent to those shown in FIGS. 8a and 8b identified with like reference numerals.

Operation of the lifting system 12 will now be described. Using the trolley 92, a lifting apparatus 10 is moved into engagement with shipping container 14. Each corner block 44 of shipping container 14 has two accessible apertures 44 and it is preferably the apertures on the long sides of the shipping container that are used in the lifting operation. The locking member 40 is rotated into the unlocked position with the oval flange 48 arranged vertically, as shown in FIGS. 1 to 4. The flange 48 is therefore aligned with the aperture 42 and the locking member 40 can be inserted into aperture 42. Handle 52 is pulled causing sliding bar 52 slide within the apertures in body 24 which in turn causes the lever 56 to rotate the locking member 40 through 90°. This rotation of the flange 48 means that the oval of the flange is now perpendicular to the oval of the aperture 42 preventing the lifting apparatus 10 being disengaged from the shipping container 14.

The frame engaging member 60 is moved into engagement with the frame of the container by rotation of the hex head 66 rotating the threaded positioning member 64 within the threaded aperture of connecting member 38 so that the disc 62 touches the frame of the shipping container 14. The standard formation of a cuboid shipping container includes a frame formed from square cross-section tubular steel defining the edges of the container. It is this frame which the engaging member 60 touches as it is sufficiently rigid to withstand the force applied to it by the lifting apparatus.

This process is repeated for each of the lifting apparatus 10 so that an apparatus is in each corner of the shipping container 14. The hydraulic hoses 68 are then connected to the hydraulic cylinder 16 in each of the lifting apparatus 10 and to the control panel 70. Hydraulic fluid under pressure is provided from pump 72 via the manifold 74 in control panel 70 through each of the hydraulic hoses into each of the lifting apparatus 10. This causes the piston 18 to move out of the cylinder barrel 20 and pushing on the foot plate 22 results in the upward movement of the cylinder barrel together with the body 24, locking member 40, frame engaging member 60 and the shipping container 14. Because the piston 18 and the foot plate 22 are not directly below the point where the weight of the shipping container is being carried by the apparatus 10, that is on the rod portion 46 of locking member 40, a turning moment is produced which forces the frame engaging member 60 against the frame of the shipping container 14. As a result, it is the weight of the container which helps to stabilise the fixing of the lifting apparatus 10 with the shipping container 14.

As soon as the container 14 is no longer in contact with the ground the pump 72 can be stopped and the pressure of the hydraulic fluid in each of the lifting apparatus 10 can be measured by the pressure sensors 76 in control panel 70. This can be used to display a total weight of the container and its contents and can also be used to calculate a weight distribution.

Further hydraulic fluid from the pump 72 can be used to raise the shipping container 14 higher to the maximum extension of the hydraulic cylinder 16. If the purpose of lifting the shipping container 14 is to move it, once sufficient height has been achieved suitable wheels can be attached to the container. These can either be in the form of one or more trolleys or the wheeled devices 82 can be attached to the corner blocks 44. Because each corner block has two apertures the wheeled devices 82 can be attached to the apertures in the corner blocks on the ends of the container 14 whilst the lifting apparatus 10 remain engaged in the apertures on the long sides of the container. Once the wheels are in place, the container can be lowered and as the wheels 84 engage the ground it is the wheeled attachment devices 82 that take the weight of the shipping container. Further retraction of the pistons 18 into the hydraulic cylinders' barrels 20 keeps them free from interference with the ground. The containing 14 can now be maneuvered and this is preferably achieved by towing using a suitable vehicle.

Once the container is in the new location the pump 72 can be reactivated to extend the pistons and lift the container off the wheels. The wheeled devices 82 can be removed and the container lowered back into engagement with the ground.

To release the locking members 40 from the corner blocks 44 the slide bar 50 is returned to its original position. Pushing the handle 52 back is achieved by lifting the sliding lock 58 from the slot in sliding bar 50 thereby freeing the sliding bar 50 to move back into the position shown in FIGS. 1 and 4. This movement, and the resultant movement of lever 56, causes rotation of the locking member 40 back to the unlocked position so that the oval flange 48 is aligned with the oval aperture 42 in corner block 44. The apparatus engaging member 104 on trolley 92 can be brought back into engagement with the trolley engaging member 106 on lifting apparatus 10 and the lifting apparatus can be removed from engagement with the shipping container.

An alternative embodiment of the system shown in FIG. 7 is represented schematically in FIG. 12. Components that are functionally equivalent to those shown in FIG. 7 have been identified with like reference numerals and some of these components are also shown in FIGS. 15, 16a and 16b. Hydraulic fluid is provided under pressure from the hydraulic pressure unit 72 into the manifold 74 via an input line 120 and returning fluid is received back in the hydraulic pressure unit via a return line 122. On a control panel 150 (see FIG. 15) of the manifold 74 are a series of five control switches in the form of leavers 124, 126, 128, 130 and 132. Four of the levers, 124, 126, 128 and 130, directly control the four apparatus 10 allowing each cylinder of the apparatus to be controlled separately thereby individually raising and lowering a corner of the container 14. The fifth lever 132 is connected to all four apparatus 10 via a series of restrictors 134, 136 and 138. The fifth lever 132 is therefore used to lift all four corners of the container 14 at the same time and the arrangement of restrictors ensures that the container is lifted evenly even if the centre of gravity of the container is closer to one corner of the container than the others. A series of gauges 140, 142, 144, 146 and 148 are used to display the weight that the hydraulic cylinders 16 are with the gauges 140, 142, 144 and 146 showing the weight being borne by each of the cylinders individually and the gauge 148 (shown on FIG. 15) showing the weight being borne by the whole system. The gauges are standard pressure gauges familiar to person skilled in the field of hydraulics and suitably connected to the system. These gauges have been calibrated to display weights with the dials labelled with weight rather than hydraulic pressure.

In FIG. 15 an operator's control panel 150 is shown which includes the control levers 124, 126, 128, 130 and 132 as well as the gauges 140, 142, 144, 146 and 148 previously referred to. Also included in the control panel 150 are a key operated locking device 152 and an emergency stop button 154. As shown in FIGS. 16a and 16b, the control panel 150 forms part of the whole system 12. A base 156 is provided on short support legs 158 between which are spaces that can be accessed by the forks of a forklift truck allowing the system 12 to be easily moved to where it is required. The hydraulic power unit 72 is located beneath the control panel 150 and the four apparatus 10 are also located on the base 156 and oriented so that a trolley 92 can easily lift each apparatus 10 from the base for maneuvering into position around the container 14.

It will be appreciated by persons skilled in the art that the above embodiments have been described by way of example only and not in any limitative sense, and that various alterations and modifications are possible without departure from the scope of the protection which is defined by the appended claims. For example, the apparatus may utilise any suitable pump for creating the hydraulic pressure required to power the hydraulic cylinders. This can include electrically driven pumps, pumps driven directly from internal combustion engines, hand pumps and pumps driven by compressed air for example from a vehicles compressed air system. Furthermore, the apparatus may utilise any lifting device using a method other than the hydraulics described above. Stabilising flanges may be added to the sides of the apparatus 10 which extend from one of the sides 28 and 30 and in used extend around the side of the frame providing further stabilisation to the apparatus when the container is lifted from the ground. Similar stabilising flanges can be added to the wheeled devices 82.

1. A lifting apparatus for use in a lifting system for lifting a cuboid shipping container, the lifting apparatus comprising:
at least one lifting device having a first portion with a ground surface engaging member and a second portion movable relative to said first portion;
at least one container corner aperture engaging member for engaging an aperture in a base corner block of a cuboid shipping container, said container corner aperture engaging member connected to said second portion and in use bearing the weight of the container; and
at least one container frame engaging member connected to said second portion for engaging a portion of a frame of the container above the base corner block and below an upper corner block vertically opposed to the base corner block.

2. A lifting apparatus according to claim 1, further comprising at least one body connected to said second portion, said container corner aperture engaging member and said container frame engaging member.

3. A lifting apparatus according to claim 1, wherein said lifting device comprises at least one hydraulic cylinder.

4. A lifting apparatus according to claim 3, wherein said first portion comprises a piston of said hydraulic cylinder and said second portion comprises a cylinder barrel of said hydraulic cylinder.

5. A lifting apparatus according to claim 1, wherein said container corner aperture engaging member comprises a rod portion connected to said second portion and a locking flange at a distal end of said rod portion, said container corner aperture engaging member being rotatable relative to said second portion between an unlocked condition in which said locking flange is able to move into and out of the aperture of the base corner block and a locked condition in which said locking flange is unable to move into or out of the aperture of the base corner block.

6. A lifting apparatus according to claim 5, further comprising at least one sliding handle having a lever connected thereto for causing the rotation of said container corner aperture engaging member between said locked and unlocked conditions.

7. A lifting apparatus according to claim 6, further comprising at least one locking member for preventing movement of said sliding handle when said container corner aperture engaging member is in said locked condition.

8. A lifting apparatus according to claim 1, wherein said container frame engaging member comprises a frame contact member and a positioning member for moving the frame contact member relative to said second portion of said lifting device.

9. A lifting apparatus according to claim 8, wherein said positioning member comprises a threaded member engaged with a threaded aperture connected to said second portion.

10. A lifting apparatus according to claim 9, wherein said threaded aperture is connected to said body.

11. A lifting apparatus according to claim 1, wherein said container frame engaging member is in use located less than 1 meter above said container corner aperture engaging member.

12. A lifting apparatus according to claim 1, further comprising at least one lifting trolley engaging member.

13. A lifting system for lifting a cuboid shipping container, the system comprising:
four lifting apparatus according to claim 1;
power connection means for connecting said lifting apparatus to a power supply; and
at least one control device for supplying power to said apparatus so as to move said first and second portions of said lifting device.

14. A lifting system according to claim 13, wherein said control device comprises at least one hydraulic fluid distribution device and said power connection means comprise a plurality of hydraulic hoses for connecting said hydraulic fluid distribution device to said lifting apparatus.

15. A lifting system according to claim 13, wherein said control device further comprises at least one pressure measuring device and at least one display device for displaying a weight being lifted by said lifting apparatus calculated from said measured pressure.

16. A lifting system according to claim 13, wherein said control device further comprises a plurality of pressure measuring devices associated with each lifting apparatus and at least one display device for displaying a weight being lifted by each said lifting apparatus calculated from each said measured pressure.

17. A lifting system according to claim 13, wherein said control device further comprises processing means for calculating a weight distribution based on each said measured pressure.

18. A lifting system according to claim 13, further comprising a wheeled trolley having a trolley body and a pivoted lifting member with an apparatus engaging portion for engaging said trolley engaging member and a handle for applying a lifting force to the pivoted lifting member thereby lifting the apparatus for transporting.

19. A lifting system according to claim 13, further comprising wheeled members for attached to the container.

20. (canceled)

21. (canceled)
